(19) United States
(12) Patent Application Publication
(10) Pub. No.: US 2018/0185959 A1
(43) Pub. Date: Jul. 5, 2018

(54) SYSTEM AND METHODS FOR FABRICATING A COMPONENT BASED ON LOCAL THERMAL CONDUCTIVITY OF A BUILD MATERIAL

(71) Applicant: General Electric Company, Schenectady, NY (US)

(72) Inventors: Harry Kirk Mathews, JR., Clifton Park, NY (US); Michael Evans Graham, Slingerlands, NY (US)

(21) Appl. No.: 15/397,050

(22) Filed: Jan. 3, 2017

(51) Int. Cl. B23K 26/03; B33Y 10/00; B33Y 30/00; B33Y 50/02

(52) U.S. Cl. CPC B23K 26/032; B33Y 50/02; B33Y 30/00; B33Y 10/00

(57) ABSTRACT

An additive manufacturing system includes an excitation energy source for generating a melt pool in a build material based on a build parameter. The system includes a sensing energy source and a first scanning device that directs the sensing energy source across the build material. The build material emits an ambient quantity of electromagnetic radiation prior to being contacted by an energy beam from the sensing energy source, and a sensing quantity of electromagnetic radiation different than the ambient quantity after contact by the energy beam. The system includes an optical system having an optical detector for detecting the sensing quantity of electromagnetic radiation and generating a detection signal in response. A computing device receives the detection signal and generates a control signal in response. The control signal is configured to modify the build parameter based on the sensing quantity of electromagnetic radiation to achieve a desired melt pool characteristic.

### BACKGROUND

The field of the disclosure relates generally to additive manufacturing systems, and more particularly, to systems and methods for adjusting a build parameter of a component based on a local thermal conductivity of the build material.

At least some additive manufacturing systems involve the buildup of a powdered material to make a component. This method can produce complex components from expensive materials at a reduced cost and with improved manufacturing efficiency. At least some known additive manufacturing systems, such as Direct Metal Laser Melting (DMLM) systems, fabricate components using a laser device and a powder material, such as, without limitation, a powdered metal. While DMLM is used herein, this term is also sometimes referred to as Direct Metal Laser Sintering (DMLS) and Selective Laser Sintering (SLS). In some known DMLM systems, component quality may be impacted by excess heat and/or variation in heat being transferred to the metal powder by the laser device within the melt pool.

In some known DMLM systems, component surface quality, particularly overhang or downward facing surfaces, is reduced due to the variation in conductive heat transfer between the powdered metal and the surrounding solid material of the component. As a result, local overheating may occur, particularly at the overhang surfaces. The melt pool produced by the laser device may become too large resulting in the melted metal spreading into the surrounding powdered metal as well as the melt pool penetrating deeper into the powder bed, pulling in additional powder into the melt pool. The increased melt pool size and depth, and the flow of molten metal may generally result in a poor surface finish of the overhang or downward facing surface. Furthermore, local overheating can result in porosity induced by boiling if the material in the melt pool becomes too hot. As a result, spatter and vapor can cause numerous problems with component manufacture and its avoidance is desired.

In addition, in some known DMLM systems, the component's dimensional accuracy and small feature resolution may be reduced due to melt pool variations because of the variability of thermal conductivity of the subsurface structures and metallic powder. As the melt pool size varies, the accuracy of printed structures may vary, especially at the edges of features.

Both of these challenges are geometry dependent. As a result, an adaptive build parameter needs to be used for every build vector to maintain control over the melt pool size. By enhancing the build parameters of the component in real-time, the quality of the surface finish throughout the printed component as well as the shape accuracy of the part may be improved. In addition, small feature resolution, often lost because of varying thermal conductivity, may also be enhanced.

### BRIEF DESCRIPTION

In one aspect, an additive manufacturing system is provided. The additive manufacturing system includes a first energy source configured to emit an excitation energy beam. The excitation energy beam is configured to generate a melt pool in a build material based on a build parameter. The system also includes a sensing energy source configured to emit an energy beam to provide sensing energy. In addition, the system includes a first scanning device configured to selectively direct the sensing energy beam across the build material. A portion of the build material is configured to emit an ambient quantity of electromagnetic radiation prior to being contacted by the sensing energy beam, and emit a sensing quantity of electromagnetic radiation different than the ambient quantity of electromagnetic radiation after being contacted by the sensing energy beam. Moreover, the system includes an optical system having an optical detector configured to detect the sensing quantity of electromagnetic radiation. The optical detector also generates a detection signal in response thereto. Furthermore, the system includes a computing device configured to receive the detection signal and to generate a control signal in response thereto. The control signal is configured to modify the build parameter based on the sensing quantity of electromagnetic radiation to achieve a desired melt pool characteristic.

In another aspect, a method for controlling an additive manufacturing system is provided. The method includes increasing a quantity of electromagnetic radiation emitted by a build material from an ambient quantity of electromagnetic radiation to a sensing quantity of electromagnetic radiation. The method also includes detecting the sensing quantity of electromagnetic radiation to determine the sensing quantity of electromagnetic radiation emitted by the build material. Furthermore, the method includes comparing, in real-time, the sensing quantity of electromagnetic radiation to a predetermined reference value stored in a calibration model of the additive manufacturing system. Also, the method includes determining a comparative value between the predetermined reference value and the sensing quantity of electromagnetic radiation. Furthermore, the method includes, based on the comparative value, modifying a build parameter of a component in real-time to achieve a desired physical property of the component.

In yet another aspect, a method for enhancing build parameters for fabricating a component using an additive manufacturing system is provided. The method includes increasing a quantity of electromagnetic radiation emitted by a build material from an ambient quantity of electromagnetic radiation to a sensing quantity of electromagnetic radiation. In addition, the method includes transmitting a portion of the sensing quantity of electromagnetic radiation to an optical detector. The method also includes determining a comparative value between a nominal quantity of electromagnetic radiation and the sensing quantity of electromagnetic radiation. Moreover, the method includes, based on the comparative value, modifying a build parameter of a component in real-time to achieve a desired physical property of the component.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary additive manufacturing system;

FIG. 2 is a schematic view of an alternative additive manufacturing system;

FIG. 3 is a schematic view of another alternative additive manufacturing system;

FIG. 4 is a block diagram of a computing device suitable for use in the additive manufacturing systems shown in FIGS. 1-3; and

FIG. 5 is a flow chart of an exemplary closed-loop method that may be implemented to control operation of the additive manufacturing system shown in FIG. 1; and

FIG. 6 is a flow chart of an exemplary closed-loop method that may be implemented to enhance the build parameters used to fabricate a component using the additive manufacturing system shown in FIG. 2.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously. In one example, real-time refers to the ability to adjust the component build parameters during the build process at the layer level so that if the measurement data indicates the power output of the build energy source should be adjusted, the build parameters are adjusted so that the melt pool size and/or temperature stay within the desired thresholds.

The systems and methods as described herein facilitate enhancing the precision of additive manufacturing systems and improving the accuracy of melt pool control during additive manufacturing processes. Specifically, the systems and methods described herein include an optical system having an optical detector configured to receive electromagnetic radiation generated by the build material after changing the energy of the build material. Thus, the additive manufacturing systems described herein provide a system for increasing or decreasing the energy of the build material prior to melting the material to fabricate a component. The increase or decrease in energy is measured and compared to a calibration model of the additive manufacturing systems. Based on the comparison, a build parameter of the component, for example, the power output of the build energy source, is adjusted to maintain a desired melt pool characteristic.

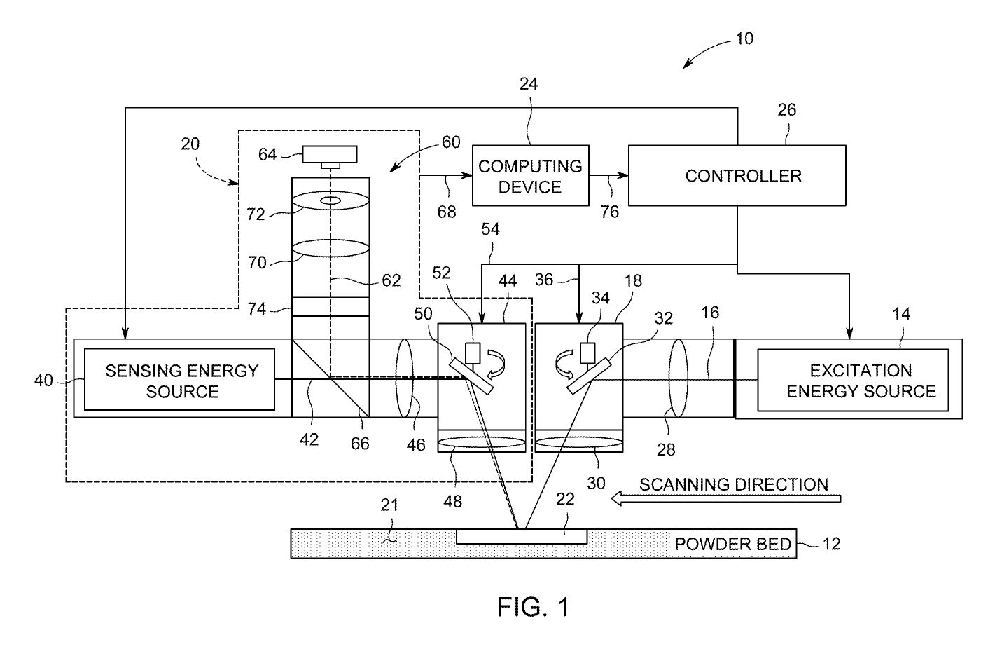

FIG. 1 is a schematic view of an exemplary additive manufacturing system 10. In the exemplary embodiment, additive manufacturing system 10 is a direct metal laser melting (DMLM) system. While additive manufacturing system 10 is described herein as a DMLM system, it is noted that additive manufacturing system 10 can be any build platform fusion process that enables additive manufacturing system 10 to fabricate a component using a focused energy device and at least one powdered material. For example, and without limitation, additive manufacturing system 10 can be a Direct Metal Laser Sintering (DMLS) system, a Selective Laser Sintering (SLS) system, a Selective Laser Melting (SLM) system, and an Electron Beam Melting (EBM) system.

In the exemplary embodiment, additive manufacturing system 10 includes a build platform 12, an excitation energy source 14 configured to generate a first energy beam 16, a excitation scanning device 18 configured to selectively direct first energy beam 16 across build platform 12, and a thermal conductivity sensing system 20 for determining a thermal conductivity of a layer of a build material 21 on build platform 12 along a build path of a component 22. Additive manufacturing system 10 also includes a computing device 24 and a controller 26 configured to control one or more components of additive manufacturing system 10, as described herein.

Build platform 12 includes the build material 21, which is melted and re-solidified during the additive manufacturing process to build component 22. In the exemplary embodiment, additive manufacturing system 10 is configured to fabricate components having a complex geometry that would be difficult to manufacture using traditional manufacturing techniques. In one embodiment, additive manufacturing system 10 is configured to fabricate aircraft components, such as fuel nozzles. Build platform 12 includes materials suitable for forming such components, including, and without limitation, gas atomized alloys of cobalt, iron, aluminum, titanium, nickel, and combinations thereof. In other embodiments, build platform 12 includes any suitable type of powdered metal material. In yet other embodiments, build platform 12 includes any suitable build material 21 that enables additive manufacturing system 10 to function as described herein, including, for example and without limitation, ceramic powders, metal-coated ceramic powders, and thermoset or thermoplastic resins.

In the exemplary embodiment, excitation energy source 14 is configured to generate first energy beam 16 having sufficient energy to at least partially melt the build material 21 of build platform 12. In one embodiment, excitation energy source 14 is a yttrium-based solid state laser configured to emit a laser beam having a wavelength of about 1070 nanometers (nm). In other embodiments, excitation energy source 14 includes any suitable type of energy device that enables additive manufacturing system 10 to function as described herein, for example, and without limitation, a continuous, a modulated, or a pulsed wave laser, an array of lasers, and an electron beam generator. Alternatively or in addition, additive manufacturing system 10 may include more than one excitation energy source 14. For example, without limitation, an alternative additive manufacturing system may have a first excitation energy source (not shown) having a first power output and a second excitation energy source (not shown) having a second power output different from the first power output, or an alternative additive manufacturing system (not shown) may have at least two excitation energy sources (not shown) having substantially the same power output. However, additive manufacturing system 10 includes any combination of excitation energy sources that enable additive manufacturing system 10 to function as described herein.

As shown in FIG. 1, excitation energy source 14 is optically coupled to optics 28 and 30 that facilitate focusing first energy beam 16 on build platform 12. In the exemplary embodiment, optic 28 includes, for example, and without limitation, a focusing element and/or a beam collimator optic disposed between excitation energy source 14 and excitation scanning device 18. Optic 30 includes, for example, and without limitation, a flat field scanning optic, or an F-theta objective 30 disposed between excitation scanning device 18 and build platform 12. F-theta objective 30 facilitates focusing the collimated first energy beam 16 independently of the deflection position of excitation scanning device 18 and always within a plane, such as the planar surface of build platform 12. This is particularly important in additive manufacturing processes where a focused spot of first energy beam 16 must be provided to all parts of build platform 12 within the processing chamber (not shown) of additive manufacturing system 10. In alternative embodiments, rather than an F-theta objective, optic 30 includes movable optical elements that facilitate dynamic focusing of first energy beam 16 to deliver a focused spot to the build platform 12. In such embodiments, optic 30 continuously changes the focus of first energy beam 16 dependent on the position of first energy beam 16 within the processing chamber so that the resultant first energy beam 16 spot is always in focus on build platform 12. In other embodiments, optic 30 is omitted where excitation scanning device 18 is a three-dimension (3D) scan galvanometer. In other alternative embodiments, additive manufacturing system 10 includes any suitable number, type, and arrangement of optics that provide a collimated and/or focused first energy beam 16 on build platform 12.

Excitation scanning device 18 is configured to direct first energy beam 16 across selective portions of build platform 12 to fabricate component 22. In the exemplary embodiment, excitation scanning device 18 is a galvanometer scanning device including a mirror 32 operatively coupled to an actuator 34. Actuator 34 is configured to move (specifically, rotate) mirror 32 in response to control signals 36 received from controller 26. As such, mirror 32 deflects first energy beam 16 across selective portions of build platform 12. Mirror 32 has any suitable configuration that enables mirror 32 to deflect first energy beam 16 towards build platform 12. In some embodiments, mirror 32 includes a reflective coating (not shown) that has a reflectance spectrum that corresponds to a wavelength of first energy beam 16.

Although excitation scanning device 18 is illustrated with a single mirror 32 and a single actuator 34, excitation scanning device 18 may include any suitable number of mirrors and actuators that enable excitation scanning device 18 to function as described herein. In one embodiment, for example, and without limitation, excitation scanning device 18 includes two mirrors (not shown) and two actuators (not shown), each actuator operatively coupled to a respective one of the mirrors. In other alternative embodiments, excitation scanning device 18 includes any suitable scanning device that enables additive manufacturing system 10 to function as described herein, for example, and without limitation, two-dimension (2D) scan galvanometers, three-dimension (3D) scan galvanometers, dynamic focusing galvanometers, and/or any other galvanometer system that is used to deflect first energy beam 16 onto build platform 12.

Thermal conductivity sensing system 20 is configured to determine a thermal conductivity of the build material 21 at a focus point or spot of a sensing energy source, such as sensing energy source 40. Variation of the energy in the build material 21 corresponds to a variation in the thermal conductance of the build material 21 at the focus point or spot of a sensing energy source.

In the exemplary embodiment, thermal conductivity sensing system 20 includes sensing energy source 40 configured to generate a second energy beam 42, a sensing scanning device 44 configured to selectively direct second energy beam 42 across build platform 12 along the build path of a component 22. In the exemplary embodiment, thermal conductivity sensing system 20 directs second energy beam 42 along the build path of a component 22 just ahead of first energy beam 16 to facilitate providing a determined thermal conductance of the build material 21 just ahead of first energy beam 16 to computing device 24. Computing device 24 and controller 26 are further configured to control one or more components of thermal conductivity sensing system 20, as described herein.

In the exemplary embodiment, sensing energy source 40 is configured to generate second energy beam 42 having a predetermined energy output sufficient to increase or decrease the energy (e.g., a temperature) of the build material 21 of build platform 12. It is noted that second energy beam 42 in only configured to increase or decrease the energy in the build material 21, and while second energy beam 42 may or may not generate a melt pool (not shown) in the build material 21, second energy beam 42 is not configured to output energy sufficient to fabricate component 22.

In one embodiment, sensing energy source 40 is a yttrium-based solid state laser configured to emit a laser beam having a wavelength of about 1070 nanometers (nm). In other embodiments, excitation energy source 14 includes any suitable type of energy device that enables thermal conductivity sensing system 20 to function as described herein, for example, and without limitation, a continuous, a modulated, or a pulsed wave laser, an array of lasers, and an electron beam generator.

As shown in FIG. 1, sensing energy source 40 is optically coupled to optics 46 and 48 that facilitate focusing second energy beam 42 on build platform 12. In the exemplary embodiment, optic 46 includes, for example, and without limitation, a focusing element and/or a beam collimator optic disposed between sensing energy source 40 and sensing scanning device 44. Optic 48 includes, for example, and without limitation, a flat field scanning optic, or an F-theta objective 48 disposed between sensing scanning device 44 and build platform 12. F-theta objective 48 facilitates focusing the collimated second energy beam 42 independently of the deflection position of sensing scanning device 44 and always within a plane, such as the planar surface of build platform 12. In alternative embodiments, rather than an F-theta objective, optic 48 includes movable optical elements that facilitate dynamic focusing of second energy beam 42 to deliver a focused spot to the build platform 12. In such embodiments, optic 48 continuously changes the focus of second energy beam 42 dependent on the position of second energy beam 42 within the processing chamber so that the resultant second energy beam 42 spot is always in focus on build platform 12. In other embodiments, optic 48 is omitted where sensing scanning device 44 is a three-dimension (3D) scan galvanometer. In other alternative embodiments, thermal conductivity sensing system 20 includes any suitable number, type, and arrangement of optics that provide a collimated and/or focused second energy beam 42 on build platform 12.

Sensing scanning device 44 is configured to direct second energy beam 42 across selective portions of build platform 12 to increase or decrease the energy in the build material 21. In the exemplary embodiment, sensing scanning device 44 is a galvanometer scanning device including a mirror 50 operatively coupled to an actuator 52. Actuator 52 is configured to move (specifically, rotate) mirror 50 in response to control signals 54 received from controller 26. As such, mirror 50 deflects second energy beam 42 across selective portions of build platform 12. Mirror 50 has any suitable configuration that enables mirror 50 to deflect second energy beam 42 towards build platform 12. In some embodiments, mirror 50 includes a reflective coating (not shown) that has a reflectance spectrum that corresponds to a wavelength of second energy beam 42.

Although sensing scanning device 44 is illustrated with a single mirror 50 and a single actuator 52, sensing scanning device 44 may include any suitable number of mirrors and actuators that enable sensing scanning device 44 to function as described herein. In one embodiment, for example, and without limitation, sensing scanning device 44 includes two mirrors (not shown) and two actuators (not shown), each actuator operatively coupled to a respective one of the mirrors. In other alternative embodiments, sensing scanning device 44 includes any suitable scanning device that enables thermal conductivity sensing system 20 to function as described herein, for example, and without limitation, two-dimension (2D) scan galvanometers, three-dimension (3D) scan galvanometers, dynamic focusing galvanometers, and/or any other galvanometer system that is used to deflect second energy beam 42 onto build platform 12.

Thermal conductivity sensing system 20 also includes an optical system 60 that is configured to detect electromagnetic radiation. For example, build material 21 emits various quantities of electromagnetic radiation. An increased or decreased quantity of electromagnetic radiation, such as electromagnetic radiation 62, is generated by build material 21 in response to second energy beam 42. Optical system 60 is configured to detect electromagnetic radiation 62 and transmit information about electromagnetic radiation 62 to computing device 24. In the exemplary embodiment, optical system 60 includes an optical detector 64 configured to detect electromagnetic radiation 62 generated by build material 21 in response to second energy beam 42, and a beam splitter 66 for dividing electromagnetic radiation 62 transmitted by optical system 60 towards optical detector 64.

Optical detector 64 is configured to detect electromagnetic radiation 62 generated by build material 21. More specifically, optical detector 64 is configured to receive electromagnetic radiation 62 generated by build material 21, and generate a detection signal (e.g., electrical, optical, etc.) 68 in response thereto. Optical detector 64 is communicatively coupled to computing device 24, and is configured to transmit detection signal 68 to computing device 24.

Optical detector 64 may include any suitable optical detector that enables optical system 60 to function as described herein, including, for example and without limitation, a photomultiplier tube, a photodiode, an infrared camera, a charged-couple device (CCD) camera, a CMOS camera, a pyrometer, or a high-speed visible-light camera. Although optical system 60 is shown and described as including a single optical detector 64, optical system 60 may include any suitable number and type of optical detectors that enables thermal conductivity sensing system 20 to function as described herein. In one embodiment, for example, optical system 60 includes a first optical detector configured to detect electromagnetic radiation within an infrared spectrum, and a second optical detector configured to detect electromagnetic radiation within a visible-light spectrum. In embodiments including more than one optical detector, optical system 60 may include a second beam splitter (not shown) configured to divide and deflect electromagnetic radiation 62 from build material 21 to a corresponding optical detector (not shown).

While optical system 60 is described as including “optical” detectors for electromagnetic radiation 62 generated by build material 21, it should be noted that use of the term “optical” is not to be equated with the term “visible.” Rather, optical system 60 may be configured to capture a wide spectral range of electromagnetic radiation. For example, optical detector 64 may be sensitive to light with wavelengths in the ultraviolet spectrum (about 200-400 nm), the visible spectrum (about 400-700 nm), the near-infrared spectrum (about 700-1,200 nm), and the infrared spectrum (about 1,200-10,000 nm). Further, because the type of electromagnetic radiation emitted by build material 21 depends on a temperature of build material 21, optical system 60 is capable of monitoring and measuring a temperature of build material 21.

In the exemplary embodiment, optical system 60 also includes an objective lens 70 positioned between sensing scanning device 44 and optical detector 64. Objective lens 70 facilitates focusing electromagnetic radiation 62 generated by build material 21 and deflected towards optical detector 64 by sensing scanning device 44 onto optical detector 64.

The exemplary embodiment also includes an optical filter 74 positioned between sensing scanning device 44 and optical detector 64. Optical filter 74 is used, for example, to filter specific portions of the electromagnetic radiation spectrum generated by build material 21 to facilitate monitoring build material 21. Optical filter 74 may be configured to block specific wavelengths of light (e.g., wavelengths substantially similar to second energy beam 42), and/or to enable specific wavelengths to pass therethrough. In the exemplary embodiment, optical filter 74 is configured to block wavelengths of electromagnetic radiation substantially similar to (e.g., within 50 nm) the wavelength of second energy beam 42. In other embodiments, optical system 60 includes any suitable type and arrangement of optical elements that enable optical system 60 to function as described herein.

Computing device 24 is a computer system that includes at least one processor (not shown in FIG. 1) that executes executable instructions to operate additive manufacturing system 10. Computing device 24 includes, for example, a calibration model of additive manufacturing system 10 and an electronic computer build file associated with a component, such as component 22. The calibration model may include, without limitation, an expected or desired melt pool size and temperature under a given set of operating conditions (e.g., a power of excitation energy source 14) of additive manufacturing system 10. The power of excitation energy source 14 required to maintain a desired melt pool size depends, in part, on the thermal conductance of build material 21 along the build path of component 22. The thermal conductance of build material 21 depends, in part, on the thermal geometry of previous layers of component 22. The build file may include build parameters that are used to control one or more components of additive manufacturing system 10. Build parameters may include, without limitation, a power of excitation energy source 14, a beam shape or profile of first energy beam 16, a scan speed of excitation scanning device 18, a position and orientation of excitation scanning device 18 (specifically, mirror 32), a power of sensing energy source 40, a beam shape or profile of second energy beam 42, a scan speed of sensing scanning device 44, and a position and orientation of sensing scanning device 44 (specifically, mirror 50). In the exemplary embodiment, computing device 24 and controller 26 are shown as separate devices. In some embodiments, however, computing device 24 and controller 26 are combined as a single device that operates as computing device 24 and controller 26, as each are described herein.

In the exemplary embodiment, computing device 24 is also configured to operate at least partially as a data acquisition device and to monitor the operation of additive manufacturing system 10 during fabrication of component 22. In one embodiment, for example, computing device 24 receives and processes detection signals 68 from optical detector 64. Computing device 24 may store information associated with build material 21 based on detection signals 68, which may be used to facilitate controlling and refining a build process for additive manufacturing system 10 or for a specific component built by additive manufacturing system 10.

Further, computing device 24 may be configured to adjust one or more build parameters in real-time based on detection signals 68 received from optical detector 64. For example, as additive manufacturing system 10 builds component 22, computing device 24 processes detection signals 68 from optical detector 64 using data processing algorithms to determine a change in energy of build material 21 in response to second energy beam 42 from sensing energy source 40 (i.e., a quantity of energy absorbed by build material 21), and/or a change in temperature of build material 21. Computing device 24 compares the change in energy and/or temperature to a predetermined reference value based on a calibration model. Computing device 24 generates control signals 76 that are transmitted or fed back to controller 26 and used to adjust one or more build parameters in real-time to adjust or control the size of the melt pool. For example, where computing device 24 detects an increased thermal conductance in build material 21, computing device 24 and/or controller 26 may increase the power output of excitation energy source 14 in real-time during the build process to adjust the melt pool. Likewise, where computing device 24 detects a decreased thermal conductance in build material 21, computing device 24 and/or controller 26 may decrease the power output of excitation energy source 14 in real-time during the build process to adjust the melt pool.

Controller 26 may include any suitable type of controller that enables additive manufacturing system 10 to function as described herein. In one embodiment, for example, controller 26 is a computer system that includes at least one processor and at least one memory device that executes executable instructions to control the operation of additive manufacturing system 10 based at least partially on instructions from human operators. Controller 26 may include, for example, a 3D model of component 22 to be fabricated by additive manufacturing system 10. Executable instructions executed by controller 26 may include controlling the power output of excitation energy source 14 and sensing energy source 40, controlling a position and scan speed of excitation scanning device 18, and controlling a position and scan speed of sensing scanning device 44.

Controller 26 is configured to control one or more components of additive manufacturing system 10 based on build parameters associated with a build file stored, for example, within computing device 24. In the exemplary embodiment, controller 26 is configured to control excitation scanning device 18 based on a build file associated with a component to be fabricated with additive manufacturing system 10. More specifically, controller 26 is configured to control the position, movement, and scan speed of mirror 32 using actuator 34 based upon a predetermined path defined by a build file associated with component 22.

In the exemplary embodiment, controller 26 is also configured to control sensing scanning device 44 to direct electromagnetic radiation 62 from build material 21 to optical detector 64. Controller 26 is configured to control the position, movement, and scan speed of mirror 50 based on at least one of the position of mirror 32 of excitation scanning device 18 and the position of the melt pool. In one embodiment, for example, the position of mirror 32 at a given time during the build process is determined, using computing device 24 and/or controller 26, based upon a predetermined path of a build file used to control the position of mirror 32. Controller 26 controls the position, movement, and scan speed of mirror 50 based upon the determined position of mirror 32 such that second energy beam 42 leads first energy beam 16 along the build path of component 22. In another embodiment, excitation scanning device 18 may be configured to communicate the position of mirror 32 to controller 26 and/or computing device 24, for example, by outputting position signals to controller 26 and/or computing device 24 that correspond to the position of mirror 32. In yet another embodiment, controller 26 controls the position, movement, and scan speed of mirror 50 based on the position of the melt pool. The location of the melt pool at a given time during the build process may be determined, for example, based upon the position of mirror 32.

Controller 26 is further configured to move sensing scanning device 44 synchronously with excitation scanning device 18 such that second energy beam 42 is proximate, or just in front of first energy beam 16 along the build path of component 22 during the additive manufacturing process. In another embodiment, controller 26 is further configured to move sensing scanning device 44 asynchronously with excitation scanning device 18 such that second energy beam 42 may pre-scan an entire build layer of component 22. The thermal conductance measures of build material 21 are determined and used to adjust one or more build parameters of component 22 prior to fabricating the respective layer of component 22.

Controller 26 may also be configured to control other components of additive manufacturing system 10, including, without limitation, excitation energy source 14. In one embodiment, for example, controller 26 controls the power output of excitation energy source 14 based on build parameters associated with a build file and detection signals 68 corresponding to the received electromagnetic radiation 62 by optical detector 64.

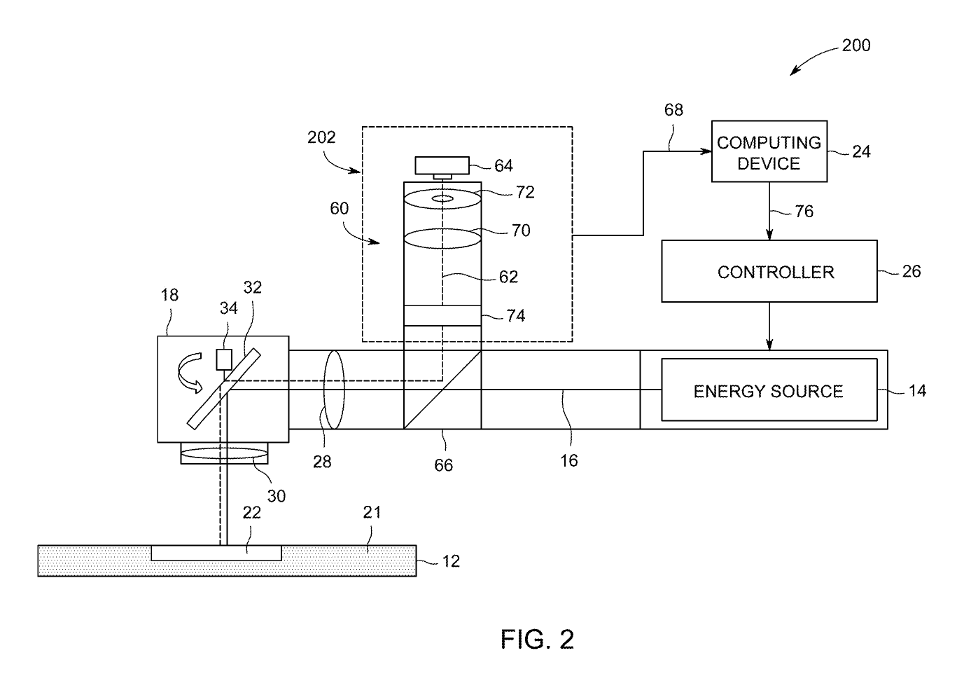

FIG. 2 is a schematic view of an alternative additive manufacturing system 200. In the exemplary embodiment, additive manufacturing system 200 includes build platform 12, excitation energy source 14 configured to generate energy beam 16, scanning device 18 configured to selectively direct energy beam 16 across build platform 12, and a thermal conductivity sensing system 202 for determining a thermal conductivity of build material 21 on build platform 12 along a build path of component 22. Additive manufacturing system 200 also includes computing device 24 and controller 26 configured to control one or more components of additive manufacturing system 200, as described herein.

In the exemplary embodiment, excitation energy source 14 is configured to generate energy beam 16 having sufficient energy to at least partially melt the build material 21 of build platform 12. In one embodiment, excitation energy source 14 is a yttrium-based solid state laser configured to emit a laser beam having a wavelength of about 1070 nanometers (nm). In other embodiments, excitation energy source 14 includes any suitable type of energy device that enables additive manufacturing system 10 to function as described herein, for example, and without limitation, a continuous, a modulated, or a pulsed wave laser, an array of lasers, and an electron beam generator. Alternatively or in addition, additive manufacturing system 10 may include more than one excitation energy source 14. For example, without limitation, an alternative additive manufacturing system may have a first building energy source (not shown) having a first power output and a second building energy source (not shown) having a second power output different from the first power output, or an alternative additive manufacturing system (not shown) may have at least two building energy sources (not shown) having substantially the same power output. However, additive manufacturing system 10 includes any combination of building energy sources that enable additive manufacturing system 10 to function as described herein.

As shown in FIG. 2, excitation energy source 14 is optically coupled to optics 28 and 30 that facilitate focusing first energy beam 16 on build platform 12. Scanning device 18 is configured to direct first energy beam 16 across selective portions of build platform 12 to fabricate component 22. In the exemplary embodiment, scanning device 18 is a galvanometer scanning device including a mirror 32 operatively coupled to an actuator 34. Although scanning device 18 is illustrated with a single mirror 32 and a single actuator 34, scanning device 18 may include any suitable number of mirrors and actuators that enable scanning device 18 to function as described herein. In other alternative embodiments, scanning device 18 includes any suitable scanning device that enables additive manufacturing system 10 to function as described herein, for example, and without limitation, two-dimension (2D) scan galvanometers, three-dimension (3D) scan galvanometers, dynamic focusing galvanometers, and/or any other galvanometer system that is used to deflect first energy beam 16 onto build platform 12.

Thermal conductivity sensing system 202 is configured to determine a thermal conductivity of the build material 21 at a focus point or spot of an excitation energy source 14. Variation of the energy in the build material 21 corresponds to a variation in the thermal conductance of the build material 21 at the focus point or spot of excitation energy source 14.

Thermal conductivity sensing system 20 also includes optical system 60 that is configured to detect electromagnetic radiation 62 generated by build material 21 in response to energy beam 16 and transmit information about electromagnetic radiation 62 to computing device 24. In the exemplary embodiment, optical system 60 includes optical detector 64 configured to detect electromagnetic radiation 62 generated by build material 21 in response to energy beam 16, and beam splitter 66 for dividing electromagnetic radiation 62 transmitted by optical system 60 towards optical detector 64, as is described herein.

Optical detector 64 is configured to detect electromagnetic radiation 62 generated by build material 21, and generate detection signals 68 in response thereto. Optical detector 64 is communicatively coupled to computing device 24, and is configured to transmit detection signal 68 to computing device 24. In particular, optical detector 64 is focused at the sport or focus point of excitation energy source 14. The focus point of excitation energy source 14 is generally just in front of the melt pool formed in build material 21.

In the exemplary embodiment, optical system 60 also includes objective lens 70, which facilitates focusing electromagnetic radiation 62 generated by build material 21 and deflected towards optical detector 64 by scanning device 18 onto optical detector 64.

The exemplary embodiment also includes an optical filter 74 positioned between scanning device 18 and optical detector 64. Optical filter 74 is used, for example, to filter specific portions of the electromagnetic radiation spectrum generated by build material 21 to facilitate monitoring build material 21.

Computing device 24 is a computer system that includes at least one processor (not shown in FIG. 1) that executes executable instructions to operate additive manufacturing system 10. Computing device 24 includes, for example, a calibration model of additive manufacturing system 10 and an electronic computer build file associated with a component, such as component 22. The calibration model may include, without limitation, an expected or desired melt pool characteristic (e.g., size and temperature) under a given set of operating conditions (e.g., a power of excitation energy source 14) of additive manufacturing system 10. The power of excitation energy source 14 required to maintain a desired melt pool characteristic (e.g., size) depends, in part, on the thermal conductance of build material 21 along the build path of component 22. The thermal conductance of build material 21 depends, in part, on the thermal geometry of previous layers of component 22. The build file may include build parameters that are used to control one or more components of additive manufacturing system 10. Build parameters may include, without limitation, a power of excitation energy source 14, a scan speed of scanning device 18, and a position and orientation of scanning device 18 (specifically, mirror 32).

In the exemplary embodiment, computing device 24 receives and processes detection signals 68 from optical detector 64, which is focused on the sport or focus point of excitation energy source 14. The focus point of excitation energy source 14 is generally just in front of the melt pool formed in build material 21. Computing device processes detection signals 68 from optical detector 64 using data processing algorithms to determine a change in energy of build material 21 in response to energy beam 16 from excitation energy source 14 (i.e., a quantity of energy absorbed by build material 21), and/or a change in temperature of build material 21. Computing device 24 compares the change in energy and/or temperature to a predetermined reference value based on the power output of excitation energy source 14 and the calibration model. Computing device 24 generates control signals 76 that are transmitted or fed back to controller 26 and used to adjust one or more build parameters in real-time to adjust or control the size of the melt pool. For example, where computing device 24 detects an increased thermal conductance in build material 21, computing device 24 and/or controller 26 may increase the power output of excitation energy source 14 in real-time during the build process to adjust the melt pool. Likewise, where computing device 24 detects a decreased thermal conductance in build material 21, computing device 24 and/or controller 26 may decrease the power output of excitation energy source 14 in real-time during the build process to adjust the melt pool.

Controller 26 is configured to control one or more components of additive manufacturing system 10 based on build parameters associated with a build file stored, for example, within computing device 24. In the exemplary embodiment, controller 26 is configured to control scanning device 18 based on a build file associated with a component to be fabricated with additive manufacturing system 10. More specifically, controller 26 is configured to control the position, movement, and scan speed of mirror 32 using actuator 34 based upon a predetermined path defined by a build file associated with component 22.

In one embodiment, controller 26 rapidly moves scanning device 18 to a focus point ahead of a melting point in build material 21 and reduces the output power of excitation energy source 14 to facilitate increasing the energy or temperature of build material 21. Computing device 24 receives and processes detection signals 68 from optical detector 64 that correspond to the forward focus point and reduced power output of excitation energy source 14 and determines a power output of excitation energy source 14 to control or maintain a characteristic (e.g., a size or temperature) of the melt pool when the focus point of excitation energy source 14 is moved back to the melting point.

In another embodiment, as described herein, excitation energy source 14 of additive manufacturing system 200 may have a first building energy source (not shown) having a first power output and a second building energy source (not shown) having a second power output different from the first power output, or an alternative additive manufacturing system (not shown) may have at least two building energy sources (not shown) having substantially the same power output. In such an embodiment, controller 26 is configured to adjust a relative position to the first building energy source to the second building energy source such that the single scanning device 18 deflects the energy beams from the first and second building energy source such that the sensing beam always leads the melting beam around the build path of component 22.

In another embodiment, excitation energy source 14 of additive manufacturing system 200 is a laser array including a plurality of rows, for example, of diode fiber lasers. The rows can be, for example, and without limitation, straight, curved, or any other shape that enables additive manufacturing system 200 to function as described herein. In the exemplary embodiment, for example, and without limitation, the laser array may include a first row of laser devices, configured to increase the energy is build material 21, for example, without creating a melt pool. The laser array may include a second row of optical fibers that are spliced to sensors, such as optical detectors 64, that measure the energy increase, such as the temperature build material 21 heated by the laser devices of the first row. Furthermore, the laser array may include a third row of laser devices configured to generate a melt pool having a desired characteristic to fabricate component 22.

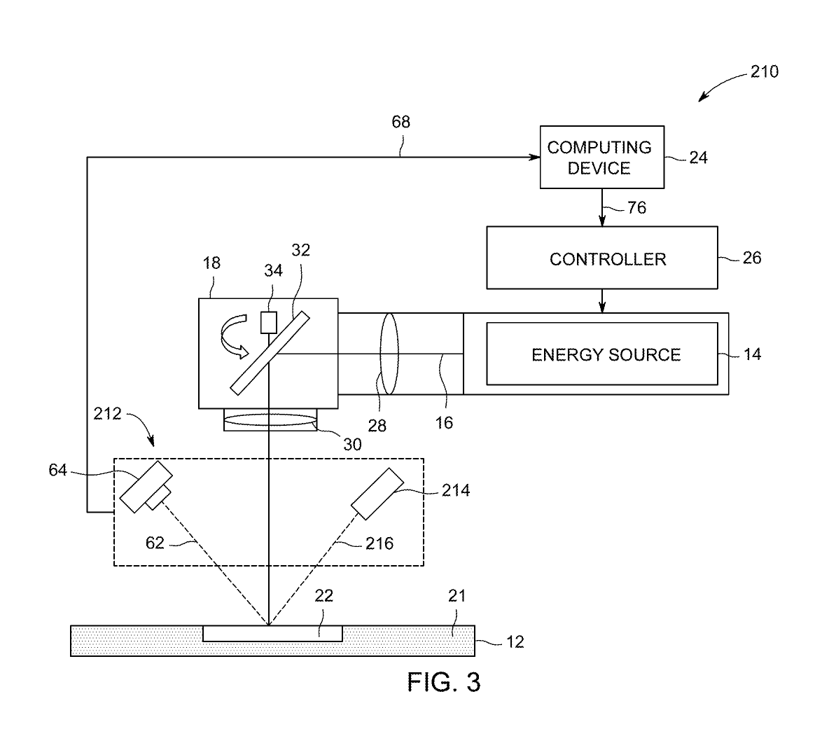

FIG. 3 is a schematic view of another alternative additive manufacturing system 210. In the exemplary embodiment, additive manufacturing system 210 includes build platform 12, primary building energy source 14 configured to generate energy beam 16, scanning device 18 configured to selectively direct energy beam 16 across build platform 12, and a thermal conductivity sensing system 212 for determining a thermal conductivity of build material 21 on build platform 12 along a build path of component 22. Additive manufacturing system 210 also includes computing device 24 and controller 26 configured to control one or more components of additive manufacturing system 200, as described herein.

Thermal conductivity sensing system 212 is configured to determine a thermal conductivity of the build material 21 at a focus point or spot of an excitation energy source 14. Variation of the energy in the build material 21 corresponds to a variation in the thermal conductance of the build material 21 at the focus point or spot of excitation energy source 14. In the exemplary embodiment, thermal conductivity sensing system 212 includes a sensing energy source 214 (for example, but not limited to a flash lamp or an overhead projector) for changing an energy state of build material 21 via an energy beam 216. In one embodiment, sensing energy source 214 emits short, intense energy pulses to uniformly increase the energy of build material 21. Electromagnetic radiation 62 emitted by build material 21 is monitored over a predetermined time interval to determine an energy rate change. Such a technique is generally referred to as a “flash IR” technique.

In the exemplary embodiment, thermal conductivity sensing system 212 includes optical detector 64, which is configured to detect and monitor electromagnetic radiation 62 emitted by build material 21. Optical detector 64 can include, for example, and without limitation, an infrared camera, a charged-couple device (CCD) camera, a CMOS camera, or a high-speed visible-light camera. Optical detector 64 is also configured to generate detection signals 68 in response thereto. Optical detector 64 is communicatively coupled to computing device 24, and is configured to transmit detection signal 68 to computing device 24. In particular, optical detector 64 is focused to observe the entire surface of build material 21. However, in some embodiments, optical detector 64 may be focused to capture only a portion of build material 21 less than the entire surface. Computing device 24 compares, in real-time, the quantity of electromagnetic radiation 62 emitted by and/or a temperature of build material 21 to the calibration model of additive manufacturing system 210 to determine a comparative value between a nominal energy rate change quantity of build material 21 and/or temperature rate change given the known energy input and the measured rate change of electromagnetic radiation 62 emitted by and/or temperature rate change of build material 21 to generate control signals 76.

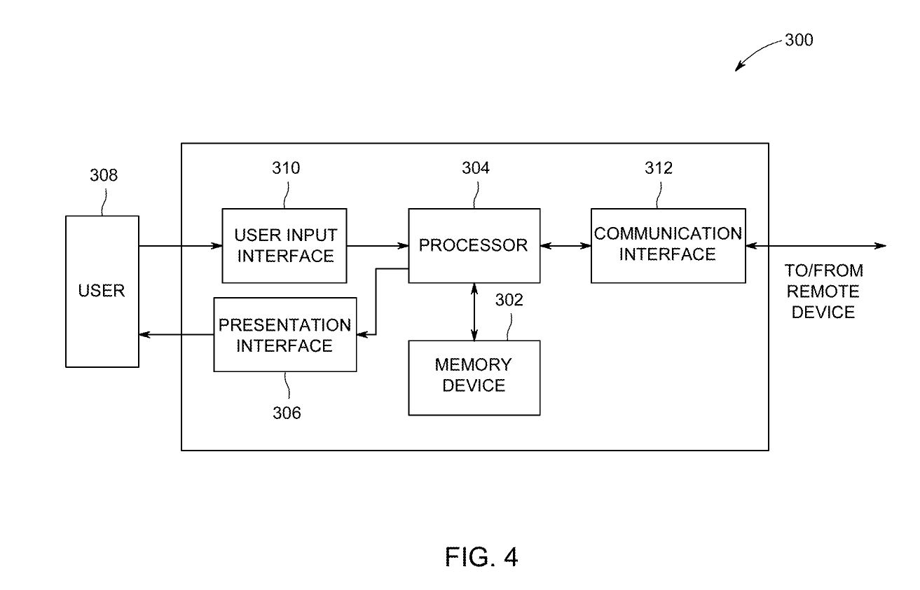

FIG. 4 is a block diagram of a computing device 300 suitable for use in additive manufacturing systems 10 and 200, for example, as computing device 24 or as part of controller 26. In the exemplary embodiment, computing device 300 includes a memory device 302 and a processor 304 coupled to memory device 302. Processor 304 may include one or more processing units, such as, without limitation, a multi-core configuration. In the exemplary embodiment, processor 304 includes a field programmable gate array (FPGA). In other embodiments, processor 304 may include any type of processor that enables computing device 300 to function as described herein. In some embodiments, executable instructions are stored in memory device 302. Computing device 300 is configurable to perform one or more executable instructions described herein by programming processor 304. For example, processor 304 may be programmed by encoding an operation as one or more executable instructions and providing the executable instructions in memory device 302. In the exemplary embodiment, memory device 302 is one or more devices that enable storage and retrieval of information such as, without limitation, executable instructions or other data. Memory device 302 may include one or more tangible, non-transitory, computer readable media, such as, without limitation, random access memory (RAM), dynamic RAM, static RAM, a solid-state disk, a hard disk, read-only memory (ROM), erasable programmable ROM, electrically erasable programmable ROM, or non-volatile RAM memory. The above memory types are exemplary only, and are thus not limiting as to the types of memory usable for storage of a computer program.

In some embodiments, computing device 300 includes a presentation interface 306 coupled to processor 304. Presentation interface 306 presents information, such as, without limitation, the operating conditions of additive manufacturing system 10, to a user 308. In one embodiment, presentation interface 306 includes a display adapter (not shown) coupled to a display device (not shown), such as, without limitation, a cathode ray tube (CRT), a liquid crystal display (LCD), an organic LED (OLED) display, or an “electronic ink” display. In some embodiments, presentation interface 306 includes one or more display devices. In addition, or alternatively, presentation interface 306 includes an audio output device (not shown), for example, without limitation, an audio adapter or a speaker (not shown).

In some embodiments, computing device 300 includes a user input interface 310. In the exemplary embodiment, user input interface 310 is coupled to processor 304 and receives input from user 308. User input interface 310 may include, for example, without limitation, a keyboard, a pointing device, a mouse, a stylus, a touch sensitive panel, such as, without limitation, a touch pad or a touch screen, and/or an audio input interface, such as, without limitation, a microphone. A single component, such as a touch screen, may function as both a display device of presentation interface 306 and user input interface 310.

In the exemplary embodiment, a communication interface 312 is coupled to processor 304 and is configured to be coupled in communication with one or more other devices, such as, without limitation, optical detector 64 and controller 26, and to perform input and output operations with respect to such devices while performing as an input channel. For example, communication interface 312 may include, without limitation, a wired network adapter, a wireless network adapter, a mobile telecommunications adapter, a serial communication adapter, or a parallel communication adapter. Communication interface 312 may receive a data signal from or transmit a data signal to one or more remote devices.

Presentation interface 306 and communication interface 312 are both capable of providing information suitable for use with the methods described herein, such as, without limitation, providing information to user 308 or processor 304. Accordingly, presentation interface 306 and communication interface 312 may be referred to as output devices. Similarly, user input interface 310 and communication interface 312 are capable of receiving information suitable for use with the methods described herein and may be referred to as input devices.

It is noted that sensing scanning device 44 is dedicated to directing second energy beam 42 of sensing energy source 40 to build platform 12 and electromagnetic radiation 62 generated by build material 21 to optical detector 64. Because additive manufacturing system 10 includes dedicated sensing scanning device 44 for directing sensing energy source 40 to build platform 12 and electromagnetic radiation 62 from build material 21 to optical detector 64, the optical path of first energy beam 16 from excitation energy source 14 to build platform 12 is free of beam splitters, such as dichroic beam splitters. Thus, dedicated sensing scanning device 44 facilitates eliminating detrimental processing affects associated with thermal lensing of beam splitters.

Further, dedicated sensing scanning device 44 enables the use of high power laser devices while avoiding detrimental processing affects associated with thermal lensing of beam splitters that may otherwise result from using such high power laser devices. The use of high power laser devices facilitates increasing the build speed of additive manufacturing systems because the size and temperature of the melt pool is generally proportional to the laser beam power. By increasing the size or temperature of the melt pool, more build material can be melted and solidified by a single pass or scan of a laser beam, thereby reducing the quantity of time needed to complete a build process as compared to additive manufacturing systems using lower power laser devices. Thus, in some embodiments, excitation energy source 14 may be a relatively high power laser device, such as a laser device configured to generate a laser beam having a power of at least about 100 watts. In one embodiment, excitation energy source 14 is configured to generate a laser beam having a power of at least approximately 200 watts and, more suitably, at least approximately 400 watts. In other embodiments, excitation energy source 14 may be configured to generate a laser beam having a power of at least approximately 1,000 watts.

Further, because additive manufacturing system 10 includes dedicated scanning device 44, the reflective coatings of components within excitation scanning device 18 and dedicated scanning device 44 may by tailored to correspond to the type of light the scanning devices reflect. Specifically, the reflective coatings used in scanning devices (such as excitation scanning device 18 and sensing scanning device 44) typically have angular-dependent reflectance spectrums. That is, the percentage of light reflected by a reflective coating varies based upon the incident angle of the reflected light. Reflective coatings may, however, have reflectance spectrums that correspond to certain wavelengths of light. That is, reflective coatings may have reflectance spectrums that are substantially angular-independent for a certain wavelength or range of wavelengths of light.

In one embodiment, for example, mirror 32 of excitation scanning device 18 may include a reflective coating that corresponds to the wavelength of first energy beam 16. That is, the reflective coating of mirror 32 may have a reflectance spectrum where the percentage of reflected light having a wavelength of about 1070 nm is substantially the same (e.g., about 100%) regardless of the angle of incidence of the reflected light. In other words, mirror 32 may include a reflective coating having a reflectance spectrum that is substantially angular-independent for light having a wavelength of about 1070 nm. Further, in some embodiments, mirror 50 may include a reflective coating having a reflectance spectrum that corresponds to sensing energy source 40 and the electromagnetic radiation that optical detector 64 is configured to detect. In one embodiment, for example, mirror 50 includes a reflective coating having a reflectance spectrum that corresponds to light within the visible spectrum. In another embodiment, mirror 50 includes a reflective coating having a reflectance spectrum that corresponds to light within the infrared spectrum.

The methods described herein may be encoded as executable instructions and algorithms embodied in a tangible, non-transitory, computer readable medium, including, without limitation, a storage device and/or a memory device. Such instructions and algorithms, when executed by a processor, cause the processor to perform at least a portion of the methods described herein. Moreover, as used herein, the term “non-transitory computer-readable media” includes all tangible, computer-readable media, such as a firmware, physical and virtual storage, CD-ROMs, DVDs, and another digital source such as a network or the Internet, as well as yet to be developed digital means, with the sole exception being a transitory, propagating signal.

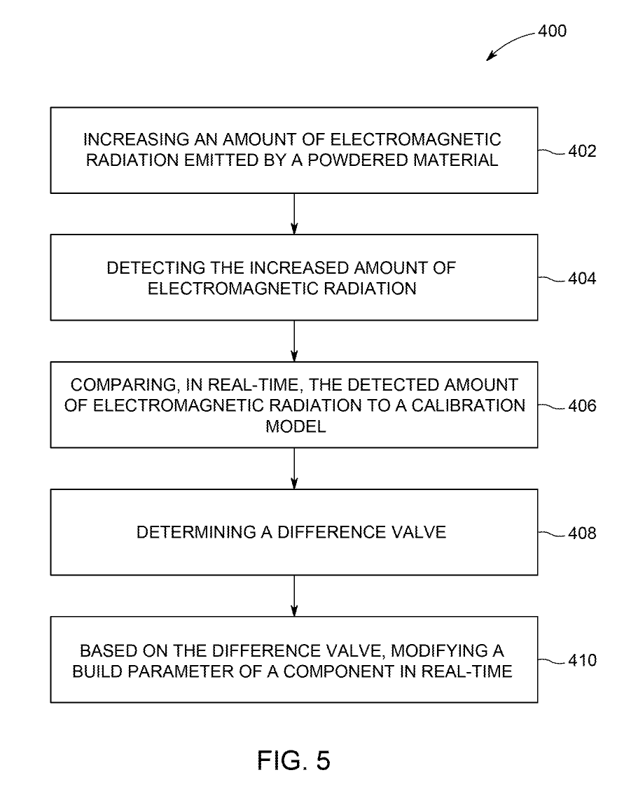

FIG. 5 is a flow chart of an exemplary closed-loop method 400 that may be implemented to control operation of additive manufacturing system 10 (shown in FIG. 1). Method 400 may be used for enhancing the build quality of component 22, and in particular, a surface finish on overhang portions of component 22. In particular, method 400 provides for improved control of the additive manufacturing process by facilitating reducing melt pool size variation by enhancing the energy source parameters for components 22 in real-time during fabrication of components 22. Furthermore, method 400 facilitates improving small feature resolution often lost because of varying thermal conductivity within build platform 12 during component fabrication.

Referring to FIGS. 1, 3 and 4, to facilitate enhancing the build quality of component 22, in the exemplary embodiment, controller 26 controls additive manufacturing system 10 and directs second energy beam 42 emitted by sensing energy source 40 onto build material 21 on build platform 12 to change 402 a quantity of energy, such as a quantity of electromagnetic radiation 62, emitted by build material 21 corresponding to the focus point of first energy beam 16. Controller 26 controls the movement of sensing scanning device 44 to scan second energy beam 42 across build platform 12 according to a predetermined path defined by the build file for component 22.

In the exemplary embodiment, optical system 60 detects 404 electromagnetic radiation 62 to determine a quantity of energy emitted by and/or a temperature of build material 21 as second energy beam 42 is scanned across build platform 12. In the exemplary embodiment, optical detector 64 includes, for example, and without limitation, a photomultiplier tube, a photodiode, a camera, or a pyrometer, to monitor and measure various thermal conditions of build material 21, generating detection signals 68 in response thereto. The thermal conditions monitored by optical detector 64 are measured values indicative of the quantity of energy (i.e., electromagnetic radiation 62) emitted by and/or a temperature of build material 21.

In the exemplary embodiment, computing device 24 includes, for example, a calibration model of the additive manufacturing system 10, comprising predetermined reference data corresponding to the quantity of energy (i.e., electromagnetic radiation 62) emitted by and/or a temperature of build material 21 based on various operating conditions of additive manufacturing system 10 and known quantities of energy put into build material 21 by, for example, sensing energy source 40 and/or excitation energy source 14. Computing device 24 receives detection signals 68 from optical detector 64 that correlate to the quantity of electromagnetic radiation 62 emitted by and/or a temperature of build material 21. More specifically, computing device 24 receives detection signals 68 from optical detector 64 and processes them using processing algorithms to determine the quantity of electromagnetic radiation 62 emitted by and/or a temperature of build material 21. Computing device 24 compares 406, in real-time, the quantity of electromagnetic radiation 62 emitted by and/or a temperature of build material 21 to the calibration model of additive manufacturing system 10 to determine 408 a comparative value between a nominal quantity of electromagnetic radiation 62 and/or temperature given the known energy input and the measured quantity of electromagnetic radiation 62 emitted by and/or temperature of build material 21 to generate control signals 76.

After determining the quantity of electromagnetic radiation 62 emitted by and/or the temperature of build material 21, computing device 24 generates control signals 76 that are transmitted to controller 26 to modify 410 the build parameters in real-time to achieve a desired physical property of component 22, for example, and without limitation, a component dimension, a surface finish, an overhang quality, and a feature resolution. For example, without limitation, if computing device 24 determines that the quantity of electromagnetic radiation 62 emitted by and/or the temperature of build material 21 is too high, computing device 24 may generate control signals 76 that are used by controller 26 to reduce the power output of excitation energy source 14 or increase the scanning speed of excitation energy source 14 to reduce the size and/or temperature of the melt pool. Alternatively, control signals 76 may be used to modify more than one of the build parameters, such as, a combination of the power output and scanning speed of excitation energy source 14. The modified build parameters are fed back to controller 26 of additive manufacturing system 10 and are used to generate the melt pool based on the modified build parameters.

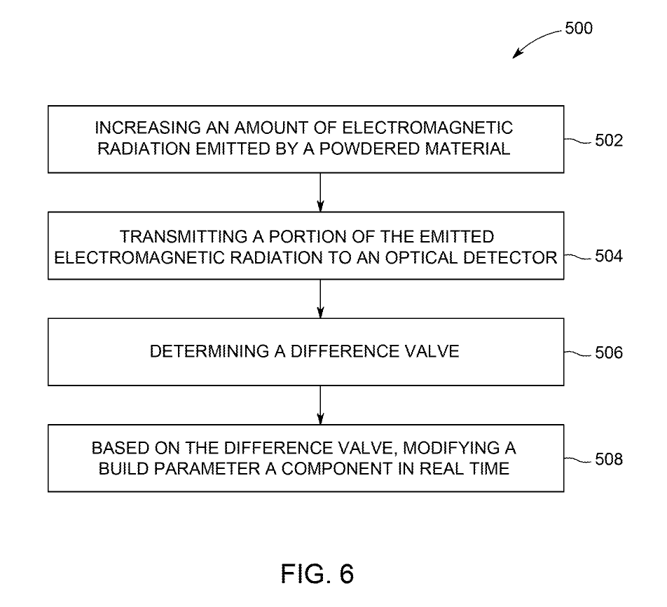

FIG. 6 is a flow chart of an exemplary closed-loop method 500 that may be implemented to enhance the build parameters used to fabricate component 22 (shown in FIG. 2) using additive manufacturing system 200 (shown in FIG. 2). Method 500 may be used for enhancing the build parameters in real-time using closed-loop control. Method 500 facilitates improving the quality of the surface finish on downward facing surfaces, or over hangs, of component 22. In addition, method 500 facilitates improving small feature resolution often lost because of varying thermal conductivity within build platform 12 during component fabrication. Referring to FIGS. 2, 3, and 5, to facilitate enhancing the build parameters of component 22, in the exemplary embodiment, controller 26 controls additive manufacturing system 200 and directs energy beam 16 at a first power output from excitation energy source 14 onto build platform 12 to increase or decrease 502 a quantity of energy, such as a quantity of electromagnetic radiation 62, emitted by build material 21 corresponding to the focus point of energy beam 16. Controller 26 controls the movement of scanning device 18 to scan energy beam 16 across build platform 12 according to a predetermined path defined by the build file for component 22.

In the exemplary embodiment, controller 26 controls the movement of scanning device 18 to scan energy beam 16 across build platform 12 according to a predetermined path defined by the build file for component 22. As energy beam 16 is scanned across build platform 12, build material 21 emits electromagnetic radiation 62 based on the first power output of excitation energy source 14. Electromagnetic radiation 62 is transmitted 504 to optical detector 64 of optical system 60. In the exemplary embodiment, optical detector 64 includes, for example, and without limitation, a photomultiplier tube, a photodiode, a camera, or a pyrometer.

Optical detector 64 is coupled to objective lens 70 to facilitate focusing electromagnetic radiation 62 onto optical detector 64. Optical detector 64 generates detection signals 68 based on electromagnetic radiation 62 received from build material 21. Computing device 24 receives detection signals 68 from optical detector 64 of optical system 60. Detection signals 68 correlate to the electromagnetic radiation 62 and/or the temperature of build material 21.

Computing device 24 compares, in real-time, the electromagnetic radiation 62 and/or the temperature of build material 21 to the calibration model of additive manufacturing system 200 to determine 506 a comparative value between a nominal electromagnetic radiation 62 and/or temperature of build material 21 and the measured electromagnetic radiation 62 and/or temperature of build material 21 to generate control signals 76. Control signals 76 are transmitted to controller 26 and are used to modify 508 the build parameters in real-time to fabricate component 22 with improved physical properties, for example, and without limitation, component dimensions, surface finish, overhang quality, and feature resolution. In particular, control signals 76 are used to adjust a second power output of excitation energy source 14 to generate a desired melt pool size and/or temperature.

The systems and methods described herein facilitate real-time enhancement of the build parameters used by an additive manufacturing system to fabricate a component. Specifically, the systems and methods described facilitate closed-loop control of an additive manufacturing system by monitoring the electromagnetic radiation emitted by and/or the temperature of a powdered build material that has been modified to a different energy state. The electromagnetic radiation emitted by and/or the temperature of the powdered build material compared to a nominal value and the comparative is used to adjust a build parameter in real-time. Enhancing the build parameters facilitates improving the quality of the component, e.g., without limitation, the physical properties such as dimensions, feature resolution, overhang quality, and surface finish. Therefore, in contrast to known additive manufacturing systems that do not adjust the component build parameters, in real-time, based on feedback of the fabrication of the component, the systems and methods described herein facilitate improving quality of the surface finish on downward facing surfaces of the component. In addition, small feature resolution, often lost because of varying thermal conductivity, may also be enhanced.

An exemplary technical effect of the methods and systems described herein includes: (a) detecting, in real-time, an electromagnetic radiation emitted by and/or a temperature of a build material having an increased quantity of energy; (b) adjusting an output power of the energy source used to build the component based on the detected electromagnetic radiation emitted by and/or a temperature of the build material; (c) improving the precision of components fabricated using additive manufacturing processes; and (d) improving the accuracy of melt pool monitoring during additive manufacturing processes.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

Exemplary embodiments of additive manufacturing systems having a system for determining a thermal conductance of a build material are described above in detail. The apparatus, systems, and methods are not limited to the specific embodiments described herein, but rather, operations of the methods and components of the systems may be utilized independently and separately from other operations or components described herein. For example, the systems, methods, and apparatus described herein may have other industrial or consumer applications and are not limited to practice with aircraft components as described herein. Rather, one or more embodiments may be implemented and utilized in connection with other industries.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An additive manufacturing system comprising:
an excitation energy source configured to emit an excitation energy beam configured to generate a melt pool in a build material based on a build parameter;
a sensing energy source configured to emit a sensing energy beam;
a first scanning device configured to selectively direct the sensing energy beam across the build material, wherein at least a portion of the build material is configured to emit an ambient quantity of electromagnetic radiation prior to being contacted by the sensing energy beam, and emit a sensing quantity of electromagnetic radiation different than the ambient quantity of electromagnetic radiation after being contacted by the sensing energy beam;
an optical system comprising an optical detector configured to detect the sensing quantity of electromagnetic radiation, and generate a detection signal in response thereto; and
a computing device configured to receive the detection signal and to generate a control signal in response thereto, the control signal configured to modify the build parameter based on the sensing quantity of electromagnetic radiation to achieve a desired melt pool characteristic.

2. The system in accordance with claim 1 further comprising a second scanning device configured to selectively direct the excitation energy beam across the build material.

3. The system in accordance with claim 2 further comprising a controller configured to move said second scanning device synchronously with said first scanning device.

4. The system in accordance with claim 3, wherein said controller is configured to move said first scanning device and said second scanning device synchronously such that the excitation energy beam and the sensing energy beam contact the build material proximate to each other, the sensing energy beam positioned in front of the excitation energy beam as the excitation energy beam and the sensing energy beam are directed across the build material.

5. The system in accordance with claim 2, wherein the build parameter includes one or more of the following: a power output of said excitation energy source, a beam shape or profile of the excitation energy beam, a scan speed of said second scanning device, and a position and orientation of said second scanning device.

6. The system in accordance with claim 1, wherein said computing device comprises a calibration model of said additive manufacturing system, said computing device further configured to compare the sensing quantity of electromagnetic radiation to the calibration model to generate the control signal.

7. The system in accordance with claim 1, wherein said optical detector comprises one or more of the following: a photomultiplier tube, a photodiode, a camera, and a pyrometer.

8. The system in accordance with claim 1, wherein said optical system comprises an objective lens.

9. The system in accordance with claim 1, wherein said optical system comprises a beam splitter.

10. A method for controlling an additive manufacturing system, said method comprising:
increasing a quantity of electromagnetic radiation emitted by a build material from an ambient quantity of electromagnetic radiation to a sensing quantity of electromagnetic radiation;
detecting the sensing quantity of electromagnetic radiation to determine the sensing quantity of electromagnetic radiation emitted by the build material;
comparing, in real-time, the sensing quantity of electromagnetic radiation to a predetermined reference value stored in a calibration model of the additive manufacturing system;
determining a comparative value between the predetermined reference value and the sensing quantity of electromagnetic radiation; and
based on the comparative value, modifying a build parameter of a component in real-time to achieve a desired physical property of the component.

11. The method in accordance with claim 10, wherein increasing a quantity of electromagnetic radiation emitted by a build material comprises contacting the build material with an energy beam.

12. The method in accordance with claim 10, wherein detecting the sensing quantity of electromagnetic radiation comprises detecting the sensing quantity of electromagnetic radiation with an optical system including at least one optical detector.

13. The method in accordance with claim 12, wherein detecting the sensing quantity of electromagnetic radiation with an optical system further comprises generating a detection signal in response to said detecting the sensing quantity of electromagnetic radiation.

14. The method in accordance with claim 12, wherein detecting the sensing quantity of electromagnetic radiation with an optical system comprises detecting the sensing quantity of electromagnetic radiation with one or more of the following: a photomultiplier tube, a photodiode, a camera, and a pyrometer.

15. The method in accordance with claim 10, wherein modifying a build parameter of a component in real-time comprises generating a control signal configured to modify the build parameter based on the sensing quantity of electromagnetic radiation to achieve a desired physical property of the component.

16. The method in accordance with claim 10, wherein the desired physical property includes one or more of the following: a component dimension, a surface finish, an overhang quality, and a feature resolution.

17. A method for enhancing build parameters for fabricating a component using an additive manufacturing system, said method comprising:
increasing a quantity of electromagnetic radiation emitted by a build material from an ambient quantity of electromagnetic radiation to a sensing quantity of electromagnetic radiation;
transmitting a portion of the sensing quantity of electromagnetic radiation to an optical detector;
determining a comparative value between a nominal quantity of electromagnetic radiation and the sensing quantity of electromagnetic radiation; and
based on the comparative value, modifying a build parameter of a component to achieve a desired physical property of the component.

18. The method in accordance with claim 17, wherein transmitting a portion of the sensing quantity of electromagnetic radiation to an optical detector comprises transmitting the portion of the sensing quantity of electromagnetic radiation to one or more of the following: a photomultiplier tube, a photodiode, a camera, and a pyrometer.

19. The method in accordance with claim 17, wherein increasing a quantity of electromagnetic radiation emitted by a build material comprises increasing the quantity of electromagnetic radiation emitted by a build material using an energy source configured to emit an energy beam at a first power output and a second power output.

20. The method in accordance with claim 17, wherein the desired set of physical properties includes one or more of the following: a component dimension, a surface finish, an overhang quality, and a feature resolution.
